(19) United States
(12) Patent Application Publication
(10) Pub. No.: US 2009/0212177 A1
(43) Pub. Date: Aug. 27, 2009

(54) Load bearing stand

(76) Inventor: Douglas Beasley, Priddis (CA)

Correspondence Address: Antony C. Edwards, P.O. Box 26020, Westbank, BC, V4T 2G3, CA

(21) Appl. No.: 12/071,642

(22) Filed: Feb. 25, 2008

(51) Int. Cl. F16M 11/00

(52) U.S. Cl. 248/127

(57) ABSTRACT

A load bearing stand which includes a concrete base and a rigid upright member having a lower-most end rigidly anchored in the base so that the lower-most end is substantially completely immersed in the base and where the upper end is adapted for rigid mounting thereon of a load supporting structure. The lower-most end of the upright member has a plurality of apertures therethrough. A corresponding plurality of rigid rods are journalled through the plurality of apertures so as to extend the rods substantially equally and oppositely from the lower-most end of the upright member and into the base to support the member. The rods and apertures are sized for snug mating of the rods through the apertures.

### FIELD OF THE INVENTION

This invention relates to the field of devices for supporting loads such as pipelines a short distance above ground and in particular to portable stands which may be economically manufactured to replace conventional pilings.

### BACKGROUND OF THE INVENTION

It is known conventionally that pipes and pipelines for the transportation of fluidized natural resources are most conveniently constructed so that the pipeline extends above ground especially in such locations such as in Canada and like locations where laying the pipeline underground would be expensive and time consuming due to for example permafrost and would also be detrimental to the environment. Where there are underground structures such as pipelines or cable, it is common for them to come above ground at such places as branch connections and pigging facilities and wellsites. It is conventional to extend the pipeline substantially horizontally above ground suspended a short distance over the ground by the use of pilings such as 3 inch screw pilings; and/or small diameter pipe pilings driven into the ground to withstand a load by either skin friction or end bearing.

Regulations require the proving of and location of underground suspended structures. Before any ground disturbance or penetration of a piling beyond 6 inches depth (Worker's Compensation Board) and 12 inches in depth (Alberta Energy Utilities Board and similar regulatory bodies) and similarly, upon abandonment of the facility; underground structures must be removed as deep as it is practical. Consequently, rather than deal with the regulatory authorities about the use of pilings, applicant has devised portable, rugged and economical stands which significantly reduce the environmental impact of supportive pipelines or other loads above ground by removing the need for ground penetration.

### SUMMARY OF THE INVENTION

In summary, the load bearing stand according to one aspect of the present invention may be characterized as including a concrete base and a rigid upright member having a lower-most end rigidly anchored in the base so that the lower-most end is substantially completely immersed in the base and where the upper end is adapted for rigid mounting thereon of a load supporting structure. The lower-most end of the upright member has a plurality of apertures therethrough.

A corresponding plurality of rigid rods are provided for journaling through the plurality of apertures so as to extend the rods substantially equally and oppositely from the lower-most end of the upright member and into the base to support the member. The rods and apertures are sized for snug mating of the rods through the apertures. The rods thereby resist the upright member pulling out of the base upon tension applied upwardly to the member and resist the member pivoting relative to the base upon a lateral load applied to the upper end and distribute downward pressure to distribute it to the base area when in compression.

The rods include a pair of rods sized so as to be snugly journalled through a corresponding two pairs of the apertures. The pair of rods extend in a substantially orthogonal orientation from the upright member. Each pair of the apertures includes a spaced apart pair of holes aligned to maintain a corresponding rod in its substantially orthogonal orientation.

Where the member is an I-beam, at least one aperture, or the pairs of apertures are formed in the lower-most end of the I-beam so that a rod may be passed through in a substantially horizontal plane intersecting the lower-most end. At least one aperture or at least one of the pairs of apertures which may be an in-line pair of apertures, pass through at least on of the flanges or web of the I-beam. A pair or pairs of rods may be parallel when mounted in a corresponding pair of apertures formed in either the web, or in the flanges, or both. The pair of rods may lie in a horizontal plane.

Where the member is a cylindrical pipe, the pairs of apertures are formed in the lower-most end of the pipe in corresponding substantially horizontal adjacent planes intersecting the lower-most end. At least one of the pairs of apertures may be an in-line pair of apertures passing through oppositely disposed side-walls of the pipe. The rods may be criss-crossed when mounted in the pairs of apertures. The rods may lie in adjacent horizontal planes when mounted in the pairs of apertures.

The base has a diameter measured substantially horizontally, and a thickness measured substantially vertically, and the upright member has a height measured substantially vertically upwardly from the base. A first ratio of the diameter to the height may be greater than or substantially equal to 3:1. A second ratio of the diameter to the thickness may be greater than or substantially equal to 6:1. In particular, the diameter of the base may be substantially 30 inches, and the height of the upright member above the base may be substantially 9 inches. The base may be formed substantially as a disc.

### BRIEF DESCRIPTION OF THE DRAWINGS

FIG. 1a is, in top perspective view, a load bearing portable stand according to a first embodiment of the present invention.

FIG. 1b is the stand of FIG. 1a in fully exploded view.

FIG. 1c is the stand of FIG. 1a in partially exploded view.

FIG. 1d is the stand of FIG. 1a showing in dotted outline a pair of rods mounted through corresponding pairs of holes in the lower-most end of the upright member which extends vertically from the base of the stand.

FIG. 1e is an alternative embodiment of the stand of FIG. 1a.

FIG. 2a is, in top perspective view, a load bearing portable stand according to a second embodiment of the present invention.

FIG. 2b is the stand of FIG. 2a in fully exploded view.

FIG. 2c is the stand of FIG. 2a in partially exploded view.

FIG. 2d is the stand of FIG. 2a showing in dotted outline a pair of rods mounted through corresponding pairs of holes in the lower-most end of the upright member which extends vertically from the base of the stand.

FIG. 3 is, in top perspective view, a pair of the load bearing stands of FIG. 1 a supporting a horizontal pipeline on vertical extensions mounted to the pair of stands.

FIG. 4 is, in bottom perspective view, a rectangular support frame mounted on four of the stands of FIG. 2a, and supporting a propane tank thereon.

FIG. 5 is, in partially exploded top perspective view, a support grate mounted atop a single stand of FIG. 2a and supporting a barrel-shaped tank thereon.

### DETAILED DESCRIPTION OF EMBODIMENTS OF THE INVENTION

With reference to the drawings wherein similar characters of reference denote corresponding parts in each view, the load bearing stand 10 according to the present invention includes a rigid upright member 12 mounted in a wide stabilizing base 14. Upright 12 serves as a vertical extension of the base, onto the upper end of which may be mounted other supporting members depending on the load bearing application to which the stand is being put. For example, if a plurality of the load bearing stands are to support a pipe extending generally horizontally over the ground, and elevated above the ground, in one embodiment vertical extension members 16 are welded or otherwise rigidly affixed to the upright members 12 so as to elevate and support at upper ends of the vertical extension members 16 cross-members 18 onto which are mounted pipe 20. The combination of uprights 12, vertical extension members 16 and cross-members 18 may for example elevate pipe 20 up to approximately three (3) feet above the ground surface 22 on which each base 14 rests.

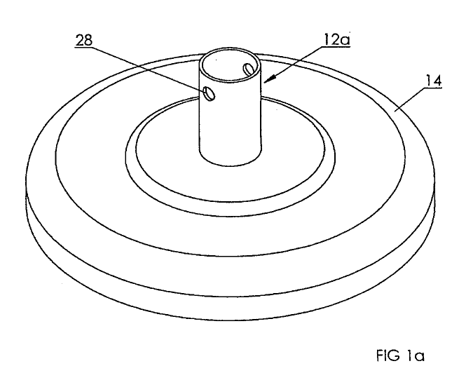

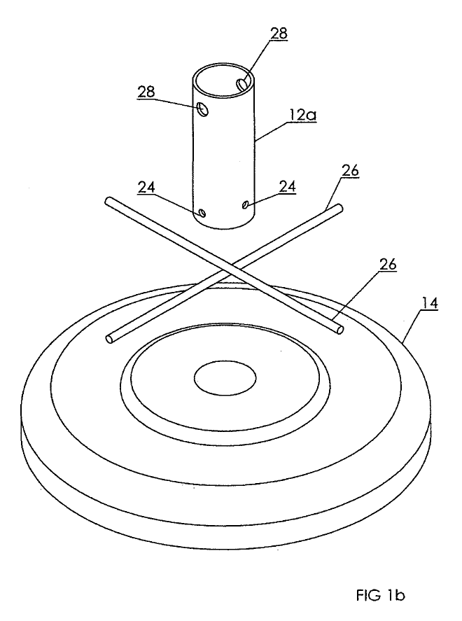

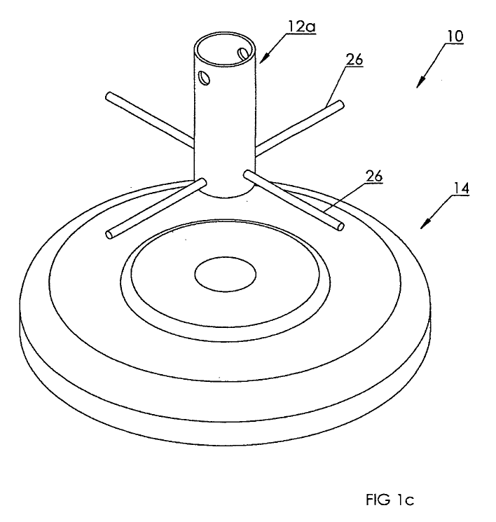

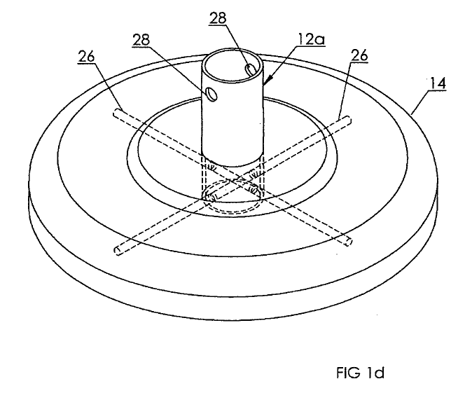

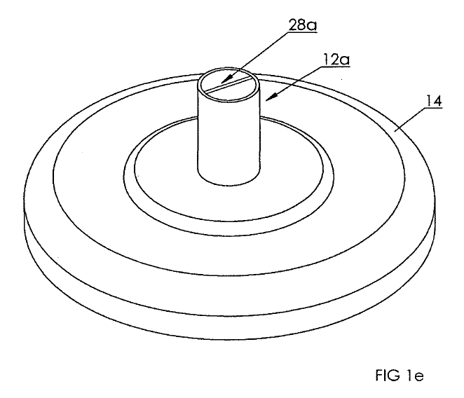

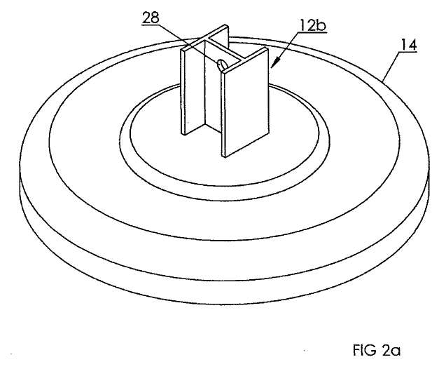

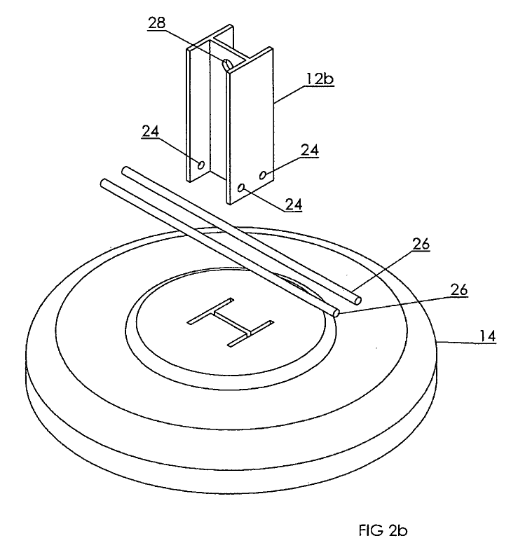

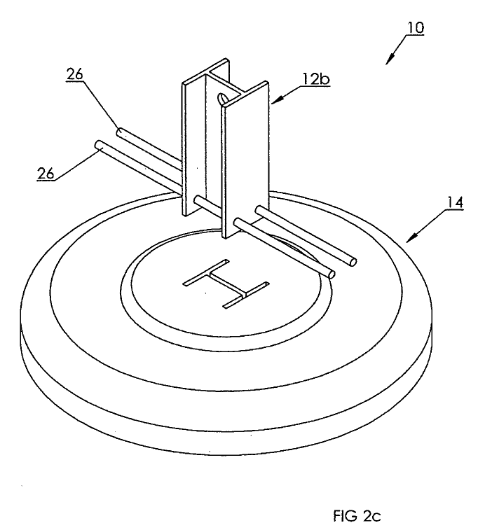

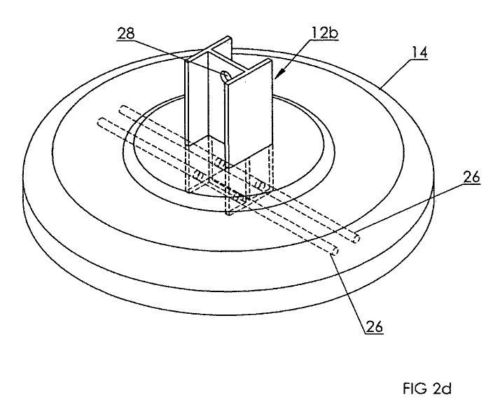

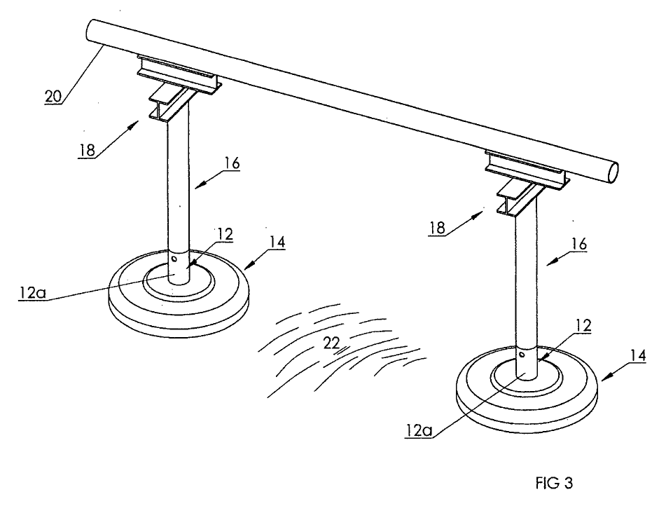

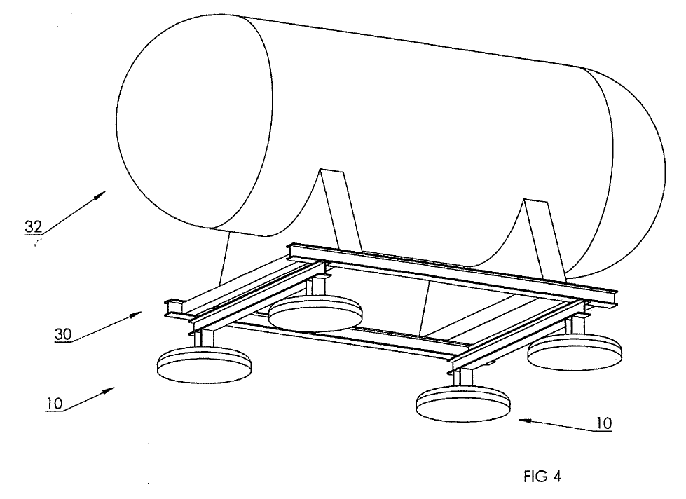

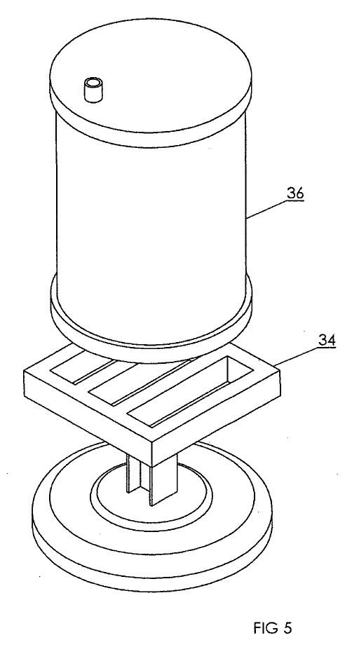

Two embodiments of upright member 12 are disclosed herein; namely, a cylinder or pipe 12a and an I-beam 12b. Other forms of member 12 will work. In both the cylinder and I-beam embodiments of member 12, apertures 24 are provided in the lower ends of the members and arranged in two horizontally spaced apart pairs to support horizontally a pair of steel re-enforcing bar rods 26. As seen in FIGS. 1c and 2c, the lower ends of upright members 12 and rods 26 are positioned in the concrete of base 14 during the process of forming base 14. Once the concrete sets the pair of rods 26 serve to anchor upright member 12 in the base and, because each rod is snugly journalled through its corresponding spaced apart horizontally aligned pair of apertures 24, each rod also serves to stabilize upright 12a so that for example, a compression or downward force on extension 16 is distributed to the base, and so that extension 16 does not pivot about its lower end relative to the base and member 12 does not easily pull out of the base.

Upright members 12a and 12b, collectively referred to herein as upright members 12 may advantageously be approximately 12 inches long, or are otherwise sufficiently long so that their length protruding above base 14 allows for welding onto their upper-most end without adversely affecting the concrete of the base. I-beam members 126 may be 15.5 lb/ft wide flange I-beams having 2 inch wide flanges spaced apart by a 6 inch deep web. Apertures 24 may be for example ⅝ inch holes.

A lifting aperture 28 or lifting eye may be a larger diameter hole centered relative to the upright member 12 and base 14 so that aperture 28 may be used to lift the stand 10. In the alternative embodiment of FIG. 1e, lifting aperture 28 is replaced with a lifting bar 28a, which may be ⅜ inch cold-rolled bar stock welded into the upper end of upright member 12a. Lifting bar 28a may therefore be used for lifting the stand using a strap for lifting wherein the strap (not shown) is looped under the bar.

In one embodiment, base 14 contains two cubic feet of concrete and weighs in the order of 210 lbs and consequently it requires light equipment such as a fork lift to raise and position each stand. Aperture 28 may be for example a 1¼ inch diameter hole. The object is to be able to lift the stand while maintaining the base substantially level. The density, volume and low-to-the-ground center of gravity of each base 14 aids in providing stability to loads placed either on the upper, horizontal ends of the upright members, or on the upper ends of the extension members 16, or on top of other application specific structure mounted onto upright members 12. Advantageously each base 14 is formed as a disc, for example in a shape formed by the use of one half of a rubber tire (i.e. cut around the circumference) with the hole in the center of the tire sealed closed with a flat plate or board to form a bowl. In this fashion the top of the disc shape is formed with somewhat smoothly bevelled circumferential edges and the bottom is planar. Base 14 may have a diameter of for example 30 inches and a height of for example 4½ inches.

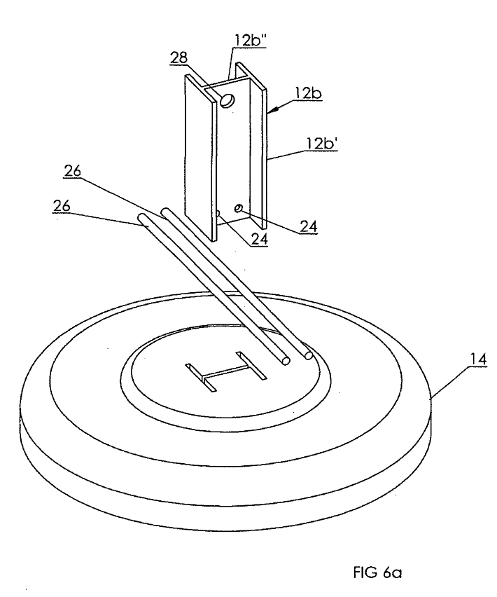

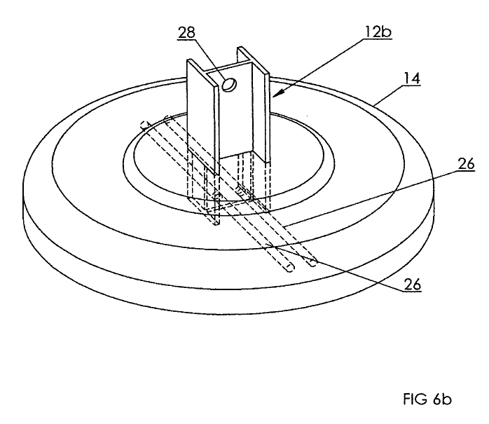

It has been found that rods 26 also serve to distribute a downward force exerted on upright member 12 so as to distribute the load across the base. Thus for example 6,000 lb-8,000 lb 15 foot segments of pipe may be supported by for example corresponding pairs of stands 10 such as support seen in FIG. 3. Or for example under the rectangular support frame 30 of FIGS. 4, four stands 10, one in each corner of the frame 30, will support a load in the order of 16,000 lbs. In the illustrated application, which is not intended to be limiting, frame 30 supports a propane tank 32.

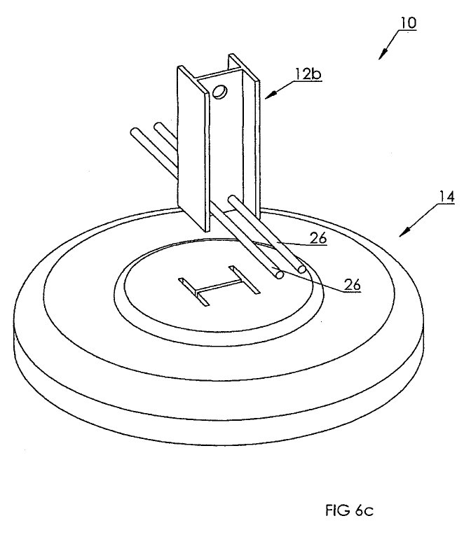

In the further application illustrated by way of example in FIG. 5, the stand 10 is used to support a grate 34 on which is placed an MCC or odour control system tank 36. Grate 34 is welded onto the upper-most end of upright member 12 so as to provide a rigid horizontal shelf supported centrally thereunder by a single stand 10.

In an alternative embodiment (not shown) upright member 12 may be a solid shaft, for example a circular cross-section, in which case the pairs of in-line apertures for supporting horizontally their corresponding rods are instead linear bores through the lower-most end of such shafts. It is intended herein that the claimed reference to pairs of apertures is meant to include such bores when extend between pairs of aperture on either end of each such bore.

In the alternative embodiment of FIGS. 6a-6c, apertures 24 are formed spaced apart as a pair of apertures across the lower-most edge of the web of I-beam 12b. Rods 26 are passed through the pair of web apertures so as to extend approximately equal distances and parallel from either side of the I-beam. In this orientation the pair of rods 26 are buried in the concrete of base 14, again to distribute a downward compression load and to resist a tensile upward load applied to the I-beam.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A load bearing stand comprising:
a concrete base;
a rigid upright member having a lower-most end rigidly anchored at said lower-most end in said base so that said lower-most end is substantially completely immersed in said base;
wherein said upright member has an upper end opposite said lower-most end, said upper end adapted for rigid mounting thereon of a load supporting structure;
and wherein said lower-most end has at least one aperture therethrough;
corresponding rigid rods for journalling through said at least one aperture so as to extend substantially equally and oppositely from said lower-most end so as to extend substantially into said base to support said member, said rods and said at least one aperture sized for snug mating of said rods through said at least one aperture, said rods thereby resisting said member pulling out of said base upon tension applied upwardly to said member and resisting said member pivoting relative to said base upon a lateral load applied to said upper end and distributing a downward pressure to said base when in compression.

2. The stand of claim 1 wherein said rods include a pair of rods sized so as to be snugly journalled through a corresponding pair of said apertures, and wherein said pair of rods extend in a substantially orthogonal orientation from said upright member.

3. The stand of claim 2 wherein said member is an I-beam and wherein said pair of apertures are formed in said lower-most end of said I-beam in a substantially horizontal plane intersecting said lower-most end.

4. The stand of claim 3 wherein said pair of apertures are an in-line pair of apertures passing through a web flange of said I-beam.

5. The stand of claim 4 wherein said pair of rods are parallel when mounted in said pair of apertures.

6. The stand of claim 3 wherein said pair of apertures extend through parallel spaced apart flanges on said I-beam which are perpendicular for a web of said I-beam and so that said rods lie in a horizontal plane.

7. The stand of claim 2 wherein said member is a cylindrical pipe and wherein said pairs of apertures are formed in said lower-most end of said pipe in corresponding substantially horizontal adjacent planes intersecting said lower-most end.

8. The stand of claim 7 wherein at least one of said pairs of apertures are an in-line pair of apertures passing through oppositely disposed side-walls of said pipe.

9. The stand of claim 8 wherein said rods are criss-crossed when mounted in said pairs of apertures.

10. The stand of claim 9 wherein said rods lie in adjacent horizontal planes when mounted in said pairs of apertures.

11. The stand of claim 1 wherein said base has a diameter measured substantially horizontally, and a thickness measured substantially vertically and wherein said upright member has a height measured substantially vertically upwardly from said base, and wherein a first ratio of said diameter to said height is greater than or substantially equal to 3:1.

12. The stand of claim 11 wherein a second ratio of said diameter to said thickness is greater than or substantially equal to 6:1.

13. The stand of claim 11 wherein said diameter of said base is substantially 30 inches, and wherein said height of said upright member above said base is substantially 9 inches.

14. The stand of claim 1 wherein said base is formed substantially as a disc.
